(19) United States
(12) Patent Application Publication
(10) Pub. No.: US 2008/0013296 A1
(43) Pub. Date: Jan. 17, 2008

(54) Structure of circuit board interface for fuel cell module

(75) Inventors: Chien-An Chen, Hsin-Chuang (TW); Wei-Jui Chuang, Hsin-Chuang (TW)

Correspondence Address: Asia Vital Components Co., Ltd., P.O. BOX 1-195, YUNG HO, TAIPEI HSIEN, 235, omitted

(73) Assignee: ASIA VITAL COMPONENTS CO., LTD., HSIN-CHUANG (TW)

(21) Appl. No.: 11/484,813

(22) Filed: Jul. 12, 2006

(51) Int. Cl. H01R 12/16

(52) U.S. Cl. 361/785

(57) ABSTRACT

A structure of a circuit board interface for electrically connecting at least one fuel cell module and at least one electronic device is disclosed. The circuit board interface comprises at least one base plate having a electronic circuit disposed thereon, a first interface positioned on the base plate for electrically connecting to the electronic circuit and the fuel cell module, a second interface positioned on the base plate for electrically connecting to the electronic circuit and the electronic device.

### FIELD OF INVENTION

The present invention relates to a structure of an interface, and more particularly to a circuit board interface for a fuel cell module.

### BACKGROUND OF INVENTION

The common circuit board of the fuel cell module is particularly for increasing the power generation efficiency of the membrane electrode assembly, as well as for improving the components related to the membrane electrode assembly. The power generation efficiency and the management of the fuel cell module are very important issues. Especially, the electronic devices are demanded to be light, thin, short and small, and accordingly a plurality of fuel cell module is designed to meet this current requirement. How to effectively collect and output the current of every assembly and meet the requirement at the same time is an important issue for the manufacturers in the field.

One conventional way is to use a wire to connect the circuit board to improve the power generation efficiency and management of the fuel cell module. However, the overall space occupation is large and the cost is high. Therefore, this conventional design still needs further improvement.

### SUMMARY OF THE INVENTION

According to an aspect of the present invention, a structure of a circuit board interface for a fuel cell module is developed by combining the connection interface of the fuel cell module with a base plate and by connecting a plurality of fuel cell modules in series or parallel to effectively accumulate the voltage or current generated. Thus, problems of conventional art described above may be effectively reduced, and the space occupation may be reduced and the throughput may be increased and the overall cost of fuel cell module may be effectively reduced.

According to another aspect of the present invention, the above-mentioned base plate may be integrally formed with another base plate used for driving at least one electronic device, and thereby further reduce the space occupation, increase the throughput and effectively reduce the overall cost of the fuel cell module.

According to another aspect of the present invention, the above-mentioned two base plates may be integrally formed to substantially reduce the space occupation as well as to simplify the assembly procedure.

According to an embodiment of the present invention, a structure of a circuit board interface for electrically connecting at least one fuel cell module and at least one electronic device is provided. The circuit board comprises at least a first base plate having an electronic circuit, a first interface positioned on the first base plate and electrically connected to the electronic circuit and the fuel cell module, and a second interface positioned on the base plate and electrically connected to the electronic circuit and the electronic device. The first and second interfaces are comprised of plug-in connectors and a connection interface of the fuel cell module is electrically connected to the first interface.

### BRIEF DESCRIPTION OF THE DRAWING

For a more complete understanding of the present invention, reference will now be made to the following detailed description of preferred embodiments taken in conjunction with the following accompanying drawings.

FIG. 1 is a perspective view of an application of a structure of a circuit board interface for a fuel cell module according to an embodiment of the present invention.

FIG. 2 is a block diagram of the circuit board interface shown in FIG. 1 according to an embodiment of the present invention.

FIG. 3 is a block diagram of the circuit board interface shown in FIG. 1 according to another embodiment of the present invention.

### DETAIL DESCRIPTION OF THE INVENTION

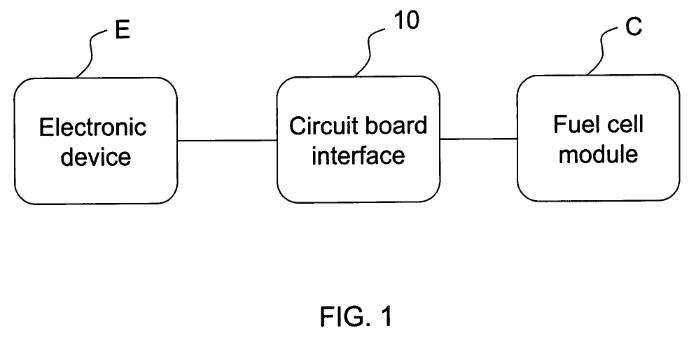

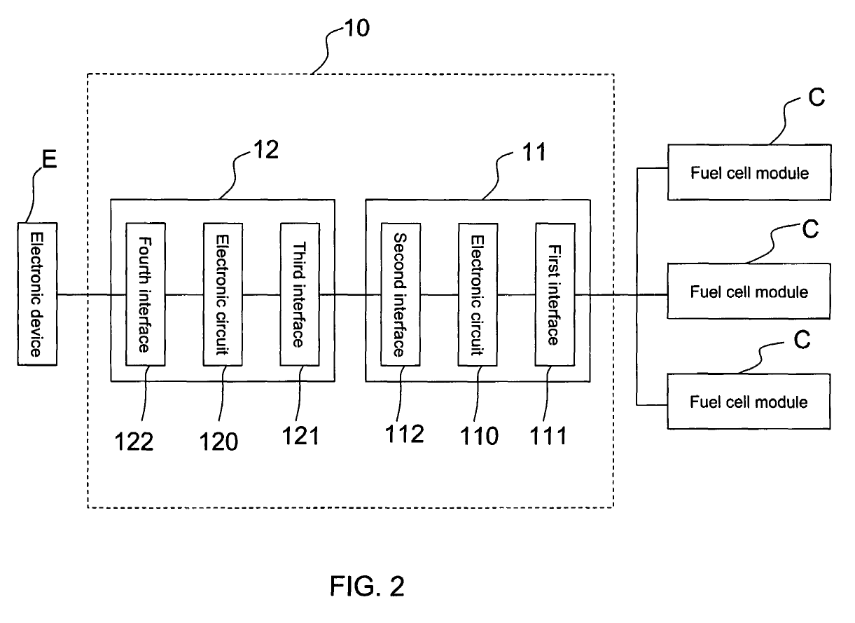

FIG. 1 is a perspective view of an application of a structure of a circuit board interface for a fuel cell module according to an embodiment of the present invention. FIG. 2 is a block diagram of the circuit board interface shown in FIG. 1 according to an embodiment of the present invention. Referring to FIG. 1 and 2, the circuit board interface 10 of the present invention may be adopted for electrically connecting to at least a fuel cell module C and at least one electronic device E to establish communication between the electronic device E and the fuel cell module C. The circuit board interface 10 comprises a first base plate 11 and a second base plate 12. The first base plate 11 and the second base 12 comprise a circuit board, for example, a printed circuit board, and the like. Electronic circuits 110 and 120 having a variety of electronic components with a variety of functionalities may be disposed on the circuit board 10. In one embodiment of the present invention, the electronic circuits 110 and 120 may comprise a power management circuit, for example, a plurality of fuel cell modules C connected in series or parallel to accumulate the voltage or current generated. The test circuit or the signal transmission circuit may be used to test or to serve as a communication channel for the fuel cell modules C may also be utilized.

In the present embodiment of the present invention, the first base plate 11 may further comprise a first interface 111 and a second interface 112, which may be used to respectively connect the above electronic circuit 110 and the fuel cell module C. The first interface 111 and the second interface 112 may comprise a plug-in connector so that the connection interface, for example, a gold finger connector or a plug-in connector and the like corresponding to the fuel cell module C can be connected to the first interface 111. Thus, a plurality of fuel cell modules C connected in series or parallel may be used to collect the voltage or current generated, and then the accumulated voltage or current may be transmitted through the electronic circuit 110 and outputted from the second interface 112.

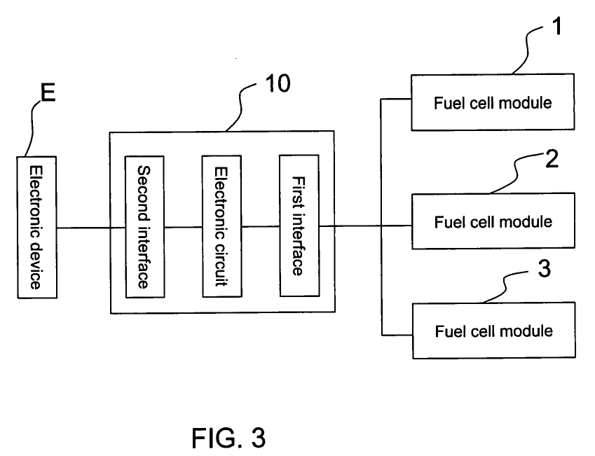

The second base plate 12 may further comprise a third interface 121 and a fourth interface 122 to respectively connect to the electronic circuit 120 and the electronic device E. The third interface 121 is electrically connected to the second interface 112 of the first base plate 11, and the first interface 111, 121 and/or the second interface 112, 122 are electrically connected to each other or connected to the above electronic device E and/or the fuel cell module C respectively, wherein the second interface 122 may be a plug-in connector. Thus the second base plate 12 can receive the power from the fuel cell module C through the first base 11 and then convert, for example, to adjust the voltage or current outputted from the fuel cell module C, to drive the pump, the fan, the converter and other components that need energy. Furthermore, in one embodiment of the present invention, the first base plate 11 and the second plate 12 may be integrally formed, as shown in FIG. 3, so that the space occupied by the second interface 112 of the first base plate 11 jointed to the third interface 121 of the second base plate 12 may be reduced. Thus, the space occupation of the circuit board interface 10 can be substantially reduced, and the first interface 111 and the third interface 121 and/or the second interface 112 and the fourth interface 122 may further comprise a plurality of plug-in connectors, and a distance between the plug-in connectors may be in a range of about 6 mm to 12 mm from a center reference point.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A structure of a circuit board interface for electrically connecting at least one fuel cell module and at least one electronic device, comprising:
at least one base plate having an electronic circuit;
a first interface disposed on said base plate for electrically connecting to said electronic circuit and said fuel cell module; and
a second interface disposed on said base plate for electrically connecting to said electronic circuit and said electronic device, wherein said first interface and said second interface are comprised of plug-in connectors so that a connection interface corresponding to said fuel cell module can be electrically connected to said first interface.

2. The structure of a circuit board interface for electrically connecting at least one fuel cell module and at least one electronic device according to claim 1, wherein said first interface and second interface comprise at least a gold finger connector.

3. The structure of a circuit board interface for electrically connecting at least one fuel cell module and at least one electronic device according to claim 1, wherein said first interface and second interface comprise slot connectors.

4. The structure of a circuit board interface for electrically connecting at least one fuel cell module and at least one electronic device according to claim 1, wherein said first interface and second interface comprise a plurality of gold finger connectors, and a distance between said gold finger connectors is in a range of 6 mm to 12 mm from a center reference point.

5. The circuit board interface structure of a fuel cell module according to claim 1, wherein said gold finger connector is plural, and a distance between said slot connectors is a range of 6 mm to 12 mm form a center reference point.

6. The structure of a circuit board interface for electrically connecting at least one fuel cell module and at least one electronic device according to claim 1, wherein said base plate comprises a first base plate and a second base plate.

7. The structure of a circuit board interface for electrically connecting at least one fuel cell module and at least one electronic device according to claim 1, wherein said base plate and said second base plate comprise a third interface and a fourth interface respectively.
